(19) United States
(12) Patent Application Publication
(10) Pub. No.: US 2024/0210898 A1
(43) Pub. Date: Jun. 27, 2024

(54) INPUT APPARATUS AND WATCH

(71) Applicant: CASIO COMPUTER CO., LTD., Tokyo (JP)

(72) Inventor: Yukio FUNABARA, Tokyo (JP)

(73) Assignee: CASIO COMPUTER CO., LTD., Tokyo (JP)

(21) Appl. No.: 18/542,982

(22) Filed: Dec. 18, 2023

(30) Foreign Application Priority Data
Dec. 21, 2022 (JP) 2022-203902

(51) Int. Cl. G04G 21/08; G04B 37/22

(52) U.S. Cl. CPC G04G 21/08; G04B 37/22

(57) ABSTRACT

An input apparatus includes a case which accommodates a module and a pressing unit having a button configured to be displaced in a certain direction and a collar area extending into a collar-like shape from an external circumferential surface of the button. The case has an external appearance area configured to constitute an external appearance of the input apparatus and a support area configured to support the collar area on the case, and the external appearance area and the support area are formed from materials which differ from each other.

### CROSS-REFERENCE TO RELATED APPLICATION

This application is based upon and claims the benefit of priority under 35 USC 119 of Japanese Patent Application No. 2022-203902 filed on Dec. 21, 2022, the entire disclosure of which, including the specification, claims, drawings, and abstract, is incorporated herein by reference in its entirety.

### BACKGROUND

### Technical Field

The present disclosure relates to an input apparatus and a watch.

### Description of the Related Art

As is disclosed in, for example, JP-A-56-6192, there is known an input apparatus including a case which accommodates a module and a button or the like provided thereon for inputting a pressing operation to the module in the case by being configured to be deformed elastically to thereby be displaced in a certain direction by a pressing operation.

### SUMMARY

According to an aspect of the present disclosure, there is provided an input apparatus including a case which accommodates a module and a pressing unit having a button configured to be displaced in a certain direction and a collar area extending into a collar-like shape from an external circumferential surface of the button, wherein the case has an external appearance area configured to constitute an external appearance of the input apparatus and a support area configured to support the collar area on the case, and wherein the external appearance area and the support area are formed from materials which differ from each other.

According to another aspect of the present disclosure, there is provided a watch including a watch module as the module of the input apparatus described above and a display area configured to display a numeral and a time.

### BRIEF DESCRIPTION OF THE DRAWINGS

FIG. 1 is an overall perspective view of a calculator-equipped watch according to a first embodiment of the present disclosure as viewed from an upper side;

FIG. 2 is an exploded perspective view of the calculator-equipped watch according to the first embodiment;

FIG. 3 is a sectional view of the calculator-equipped watch according to the first embodiment taken along a line III-III in FIG. 1;

FIG. 4 is a partially enlarged sectional view of the calculator-equipped watch according to the first embodiment taken along a line IV-IV in FIG. 1;

FIG. 5 is a partially enlarged sectional view of a calculator-equipped watch according to a second embodiment of the present disclosure; and

FIG. 6 is a partially enlarged sectional view of a calculator-equipped watch according to a comparison example.

### DESCRIPTION OF THE EMBODIMENT

### (First Embodiment)

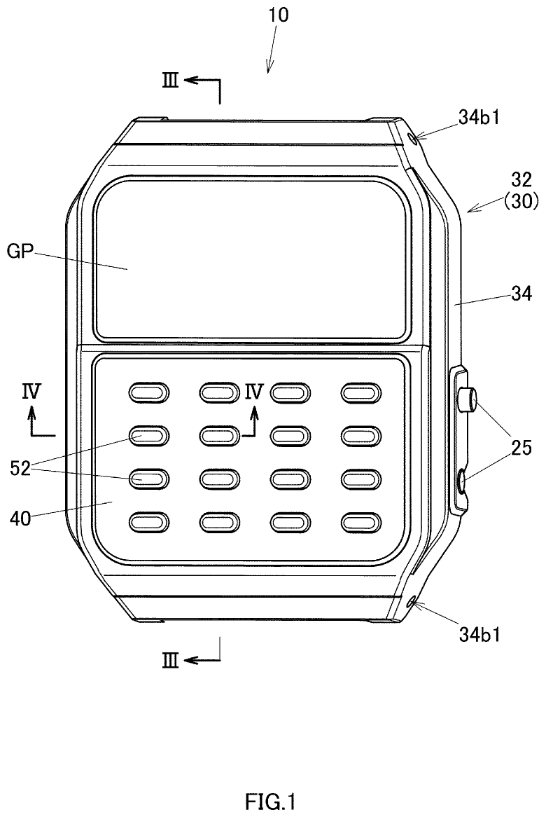

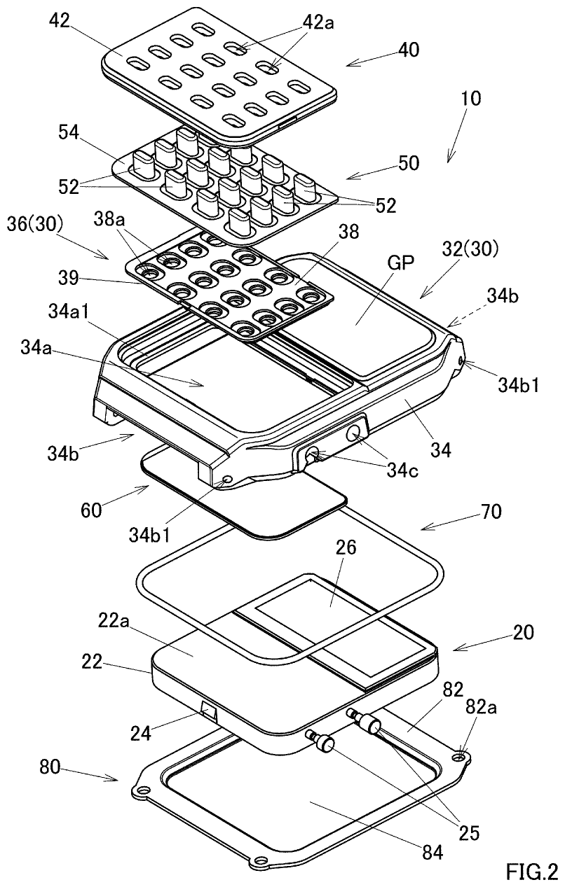

Referring to FIGS. 1 to 4, a first embodiment of the present disclosure will be described. As shown in FIGS. 1 and 2, a calculator-equipped watch (an input apparatus, a watch) 10 according to the first embodiment is a watch equipped with a calculator function and includes a watch module (a module) 20, a case 30 which accommodates the watch module 20, a button panel 40, a key button unit (a pressing unit) 50, a contact sheet 60, a gasket 70, and a rear lid 80. A part of the key button unit 50 and a glass panel GP are exposed from a side of the case 30 which is opposite to a side of the case 30 where the rear lid 80 is provided. Additionally, a watchband opening 34b is provided individually in one side surface of the case 30 and a side surface of the case 30 which is opposite to the one side surface.

In the following description, the side of the case 30 from which the key button unit 50 and the glass panel GP are exposed (a front side in FIG. 1, and an upper side in FIG. 2) is referred to as an upper side of the calculator-equipped watch 10, while the opposite side of the case 30 to the side from which the key button unit 50 and the glass panel GP are exposed (the side of the case 30 where the rear lid 80 is provided) is referred to as a lower side of the calculator-equipped watch 10. In addition, when the case 30 is seen from the side where the glass panel GP is provided, a side of the case 30 where the watchband opening 34b which is provided in the one side surface, that is, a lower side surface of the case 30 exists (a lower side in FIG. 1, and a left lower side in FIG. 2) is referred to as a front side of the calculator-equipped watch 10, while an opposite side of the case 30 where the other watchband opening 34b is provided in the opposite side surface (a side where a first opening is provided) is referred to as a rear side of the calculator-equipped watch 10. Further, as shown in FIG. 1, when the case 30 is seen from the upper side, that is, the side where the glass panel GP is provided, a right side of the case 30 (a right side in FIG. 1, and a right lower side in FIG. 2) is referred to as a right side of the calculator-equipped watch 10, while an opposite side of the case 30 to the right side thereof is referred to as a left side of the calculator-equipped watch 10.

As shown in FIG. 2, the watch module 20 has substantially a rectangular parallelepiped shape having four rounded corners and includes a casing 22 which incorporates mechanisms constituting a watch and a calculator. A claw-shaped engagement tooth 24 is provided individually on a front side surface and a rear side surface of the casing 22 for use in bringing the casing 22 into engagement with the case 30 for attachment (an engagement tooth on the rear side surface is not shown). Two buttons 25 are provided on a right side surface of the casing 22 in such a manner as to be aligned in a front-rear direction for controlling a watch function of the calculator-equipped watch 10. The casing 22 has a display area 26 extending substantially over a rear half area of an upper surface 22a. A liquid crystal panel is provided on the display area 26 for displaying digitally times when a watch function is used and numerals when a calculator function is used. A wiring circuit board, not shown, is provided substantially in a front half area of the upper surface 22a of the casing 22.

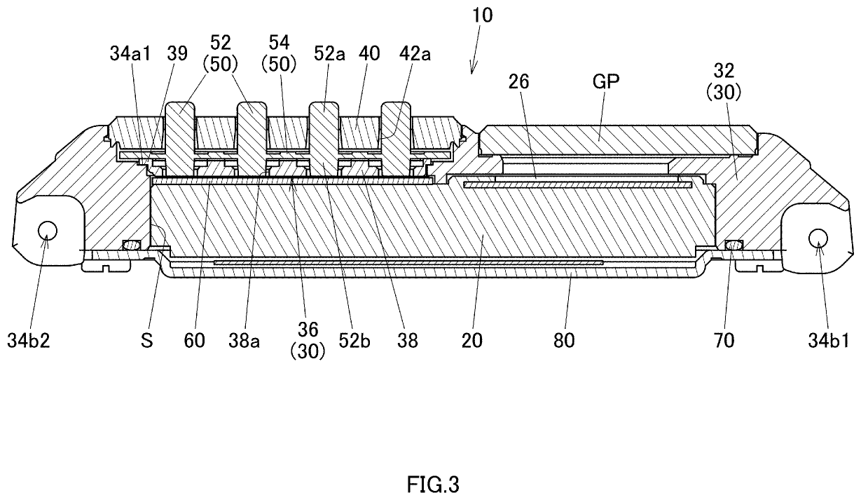

The case 30 has an external appearance body 32 constituting an external appearance of the calculator-equipped watch 10 and a support 36 which is separated from the external appearance body 32 to constitute a separate unit. The external appearance body 32 is made up of a substantially box-shaped box unit 34 which is opened downwards and is formed from an ABS resin. The glass panel GP is fused substantially to a rear half area of an upper surface side of the box unit 34 in such a state that airtightness is secured between the box unit 34 and the glass panel GP. A button opening 34a is opened substantially into a laterally elongated rectangular panel shape in an up-down direction substantially in a front half area of the upper surface side of the box unit 34 to accommodate and hold the support 36 and the key button unit 50 therein. A step 34a1 is provided along an internal circumferential portion of the button opening 34a in such a manner as to constitute a step on which the support 36 rests. A space inside the box unit 34 which communicates with the button opening 34a constitutes an accommodation space S which accommodates the casing 22 (refer to FIG. 3).

The watchband opening 34b, which is opened in the front-rear direction, is provided individually in a front side surface and a rear side surface of the box unit 34. A pair of watchband retaining holes 34b1 is provided in both left and right side surfaces of the box unit 34 near each watchband opening 34b. Watchbands configured to be worn on the wrist of a user are used when the calculator-equipped watch 10 is used as a wristwatch, and for this, a watchband on one side is retained via the pair of watchband retaining holes 34b1 on the one side, while a watchband on the other side is retained via the pair of watchband retraining holes 3b1 on the other side. In addition, button passage holes 34c are provided in a right side surface of the box unit 34 so that the buttons 25 are passed through the corresponding button passage holes 34c for exposure to the outside. Here, a gold plating (plating) treatment is applied to a surface of the box unit 34 of the external appearance body 32.

The support 36 is made up of a panel unit 38 having substantially a laterally elongated rectangular panel shape and is formed from a resin material which differs from the resin material from which the external appearance body 32 is formed. Specifically speaking, the support 36 is made from a polyacetal resin which has a superior sliding property with respect to a rubber material. Multiple button passage holes (through holes) 38a are provided at equal intervals in a matrix pattern in the panel unit 38 in such a manner as to penetrate a panel surface of the panel unit 38 so that portions of the key button unit 50 are slidably passed through the corresponding button passage holes 38a in the up-down direction. Specifically speaking, in total, 16 button passage holes 38a are provided in four columns in the front-rear direction and four rows in a left-right direction in the panel unit 38.

A protruding portion 39 is provided along an external circumferential portion of the panel unit 38 in such a manner as to protrude externally from the panel unit 38 while protruding slightly upwards to form a step. The support 36 is supported on the box unit 34 as a result of the protruding portion 39 resting on the step 34a of the box unit 34 to thereby constitute a part of the case 30 (refer to FIG. 3). Here, being different from the surface of the external appearance body 32, no gold plating treatment is applied to a surface of the support 36. A size of an opening of the button passage hole 38a is made slightly larger than an external circumferential size of a portion of the key button unit 50, which will be described later, which lies on a lower side of a collar 54, whereby a slight gap is defined between each key button 52 and the corresponding button passage hole 38a.

The rear lid 80 is made up of a metallic unit of a shallow plate shape and has an edge portion 82 provided along an external circumference thereof and a concave portion 84 which is recessed downwards inside the edge portion 82. A screw hole 82a is provided individually in four corners of the edge portion 82. The concave portion 84 is shaped and sized so that a lower portion of the casing 22 is fitted therein. The rear lid 80 is attached to a lower side of the box unit 34 of the case 30 with screws (not shown) which are individually passed through the screw holes 82a in such a state that the lower portion of the casing 22 is fitted in the concave portion 84. The gasket 70 is a rubber ring and is disposed between the box unit 34 and the edge portion 82 of the rear lid 80 in such a manner as to surround the casing 22, whereby the gasket 70 functions as a packing for sealing the interior of the accommodation space S (refer to FIG. 3).

The key button unit 50 is made from elastically deformable rubber and has multiple key buttons (press buttons) 52 and the collar 54 (collar area) 54. The multiple key buttons 52 each have substantially a laterally elongated cylindrical shape and are each hollow inside so as to enable a pressing operation thereon. Here, 16 key buttons 52 are provided in a matrix pattern so as to correspond to the layout of the multiple button passage holes 38a of the support 36. The collar 54 extends horizontally into a collar-like shape from positions on external circumferential surfaces of the individual key buttons 52 which lie close to lower ends thereof towards the outside.

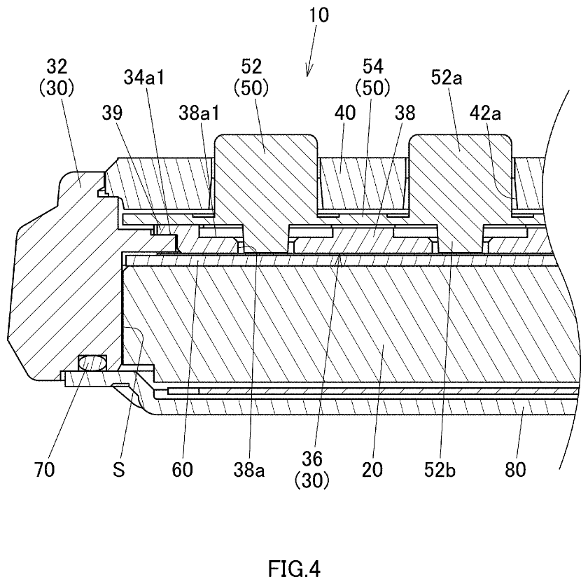

The collar 54 extends from the individual key buttons 52 in such a manner as to connect the adjacent key buttons 52, and hence, the collar 54 is provided into a sheet as a whole. A portion of each key button 52 which lies on a lower side of the collar 54 (hereinafter, referred to as a “key button lower portion 52b”) has substantially a cylindrical shape, and a dimension in the front-rear direction of the key button lower portion 52b is made substantially the same as such a dimension of a portion of each key button 52 which lies on an upper side of the collar 54 (hereinafter, referred to as an “key button upper portion 52a”) (refer to FIG. 3). On the other hand, a dimension in the left-right direction of the key button lower portion 52b is made smaller than such a dimension of the key button upper portion 52a (refer to FIG. 4).

The collar 54 is provided one size larger than the support 36. As shown in FIGS. 3 and 4, the collar 54 rests on the protruding portion 39 of the support 36 at a portion of a lower surface thereof which lies close to an external circumference thereof. As a result, the key button unit 50 is configured to be supported by the support 36. In other words, the support 36 functions as a so-called button bearing unit for bearing key buttons 52 which are pressed when a pressing operation is performed on the key button unit 50. With the collar 54 resting on the protruding portion 39, a lower end portion of each key button 52 is passed through the corresponding button passage hole 38a in the support 36. In addition, with the collar 54 resting on the protruding portion 39, a slight gap is defined between an upper surface of the panel unit 38 and the lower surface of the collar 54, whereby the collar 54 is allowed to slightly deflect downwards.

The button panel 40 is a glass panel and is made up of a panel unit 42 of a thick panel shape. Multiple panel holes 42a are provided in the panel unit 42, so that the key button upper portions 52a are passed through the corresponding panel holes 42a in the up-down direction to be exposed therefrom to the outside. The multiple panel holes 42a each have an opening of a laterally elongated oval shape so as to correspond to shapes of the individual or corresponding key buttons 52 in a plan view. 16 panel holes 42a are provided in a matrix pattern so as to correspond to the layout of the key buttons 52 which are provided in the same number and manner. The button panel 40 is tightly secured to an open end of the button opening 34a along an external circumferential portion thereof to thereby prevent dust or the like from entering an interior of the button opening 34a.

Upper ends of the key button upper portions 52a which are passed through the corresponding panel holes 42a are exposed upwardly of the button panel 40. The user presses the key button upper portions 52a which are exposed from the button panel 40 to execute the calculation function of the calculator-equipped watch 10. An opening size of each panel hole 42a is made slightly larger than an external circumferential size of the corresponding key button upper portion 52a, whereby a slight gap is defined between each key button 52 and the corresponding panel hole 42a. As a result, the user can press the key buttons 52 smoothly.

The contact sheet 60 is a conductive sheet and is shaped and sized so that a sheet surface thereof is substantially the same as a panel surface of the panel unit 38 of the support 36. The contact sheet 60 is provided between the key buttons 52 of the key button unit 50 and the watch module 20. The contact sheet 60 is in contact with or in the proximity of the key button lower portions 52b at an upper surface thereof, so that when the key button 52 is pressed, a conducting state is established with the wiring circuit board provided on the watch module 20.

With the calculator-equipped watch 10 of the first embodiment which is configured as described heretofore, since the external appearance body 32 and the support 36, which make up the case 30, are provided as the separate constituent units, the external appearance body 32 and the support 36 can be provided by molding them separately for production of the calculator-equipped watch 10. As a result, molding conditions for the support 36 can be set without depending upon molding conditions for the external appearance body 32, whereby the dimensional accuracy of the support 36 can be enhanced for production thereof. As a result, the support 36 (the panel unit 38) can be made thin. This enables a thickness dimension (a dimension in the up-down direction) of the key button 52 can be made small in accordance with the thickness of the panel unit 38. Thus, with the first embodiment, the panel unit 38 is made very thin compared with the thickness dimension of the key button 52, and the panel unit 38 has a thickness of, for example, 0.35 mm.

Next, the operation of the calculator-equipped watch 10 according to the first embodiment will be described. When the user presses the key button 52 downward which is exposed from the button panel 40, the key button 52 so pressed is elastically deformed, and the key button lower portion 52b presses the contact sheet 60, whereby a conducting state is established between the contact sheet 60 and the wiring circuit board on the watch module 20, enabling a function corresponding to the key button 52 so pressed to be executed. As this occurs, the collar 54 lying around a circumference of the key button 52 so pressed is pressed downwards (in a pressing direction) in association with the pressing operation performed on the key button 52, and the panel unit 38 of the support 36 bears a downward load. That is, the support 36 functions as a bearing unit for supporting the collar 54 on the case 30 and bearing the load from the key button 52.

In addition, since the thickness dimension of the button panel 40 is made larger than the thickness dimension of the panel unit 38 of the support 36, when the key button 52 is pressed, the key button upper portion 52a is restrained from deviating in a planar direction as a result of the key button upper portion 52a coming into interference with an internal surface of the corresponding panel hole 42a. Further, since the support 36 is formed from polyacetal resin which has the superior sliding property with respect to a rubber material, there is no risk of the key button lower portion 52b being caught on the button passage hole when the key button 52 is pressed, whereby the key button 52 can be pressed smoothly.

Thus, as has been described heretofore, the calculator-equipped watch 10 according to the first embodiment has the case 30 which accommodates the watch module 20, and the key button unit 50 having the key buttons 52 which can be displaced in a certain direction by a pressing operation and the collar 54 which extends into the collar-like shape from the external circumferential surfaces of the key buttons 52 and configured to input a pressing operation of the key button 52 into the watch module 20. Then, the case 30 has the external appearance body 32 which constitutes the external appearance of the watch module 20 and the support 30 for supporting the collar 54 on the case 30. In addition, the external appearance body 32 is formed from the material which differs from the material from which the support 36 is formed.

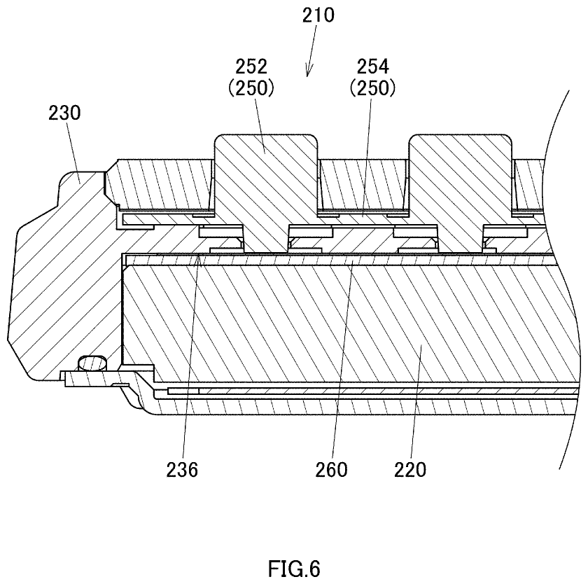

Here, an example of a calculator-equipped watch (an input apparatus) according to a comparison example will be described. FIG. 6 shows a mobile calculator-equipped watch (an input apparatus) according to a comparison example including a case which accommodates a module and a key button unit which can be displaced in a certain direction by a pressing operation, wherein a collar which extends into a collar-like shape is provided on an external circumferential surface of the key button unit in such a manner as to prevent the key button unit from being pressed more than a predetermined depth. With this mobile calculator-equipped watch, a key button unit holder is provided which is configured to be brought into abutment with the collar of the key button unit in such a state that the key button unit is pressed to the predetermined depth.

A calculator-equipped watch (an input apparatus) 210 of the comparison example includes a case 230 which accommodates a watch module 220 and a rubber key button unit 250. The key button unit 250 has a main body 252 which extends in the up-down direction and a collar 254 which extends sideways into a collar-like shape from an external circumferential surface of the main body 252, and an upper portion of the key button unit 250 is exposed from the case 230. A conductive contact sheet 260 is provided between the key button unit 250 and the watch module 220. With this calculator-equipped watch 210, a support area 236 for supporting the collar 254 of the key button unit 250 on a part of the case 230 is provided in such a manner as to be interposed between the collar and the contact sheet. As a result, with the calculator-equipped watch 210, the key button unit 250 is configured to be supported on the case 230 in a stable fashion.

Incidentally, with the input apparatus described above, the thickness dimension of the key button unit needs to be as small as possible so as to secure the operability thereof which would otherwise be deteriorated when the key button unit is elastically deformed to buckle. As a result, the support area for supporting the collar of the key button unit needs to be provided as thin as possible. With the calculator-equipped watch 210 shown in FIG. 6, however, since the support area 236 is provided integrally together with the case 230 which constitutes the external appearance of the calculator-equipped watch 210, it is difficult from the viewpoint of molding conditions that the dimensional accuracy of the support area 236 becomes compatible with the dimensional accuracy of an external appearance portion of the case 230, and hence, it has been difficult to reduce the thickness of the support area 236.

On the other hand, according to the configuration of the calculator-equipped watch 10 of the first embodiment, since the external appearance body 32 and the support 36 can be provided by molding them under the different molding conditions, the dimensional accuracy of the support 36 can be enhanced without depending on the dimensional accuracy of the external appearance body 32 while maintaining the dimensional accuracy of the external appearance of the calculator-equipped watch 10. In this way, the support 36 can be provided thin as the result of the dimensional accuracy of the external appearance body 32 and the dimensional accuracy of the support 36 being made to become compatible with each other, and in association with this, the thickness dimension of the key buttons 52 can be reduced. As a result, the key button unit 50 can be restrained from being pressed to buckle, whereby the operability of the key button unit 50 can be restrained from being deteriorated. Thus, with the first embodiment, the calculator-equipped watch 10 can be realized which is superior in molding the support 36 for supporting the collar 54 of the key button unit 50 thin.

In addition, with the calculator-equipped watch 10, the gold plating treatment is applied to the surface of the external appearance body 32, while no gold plating treatment is applied to the surface of the support 36. In the event that the support 36 is provided integrally together with the external appearance body 32 as a part of the case 30 as in the case with the comparison example, when a gold plating treatment is applied to the surface of the external appearance body 32, there is caused a risk that the gold plating treatment is also applied to the surface of the support 36. However, in the first embodiment, the external appearance body 32 and the support 36 are provided as the separate constituent units, whereby in the course of manufacturing the calculator-equipped watch 10, the gold plating treatment can be applied to only the external appearance body 32, while no gold plating treatment can be applied to the support 36. As a result, a reduction in dimensional accuracy of the support 36, which would result from the application of a gold plating treatment to the surface of the support 36, can be prevented. Further, since the surface area to which such a plating treatment is applied can be reduced compared with the configuration of the comparison example, the production cost associated with the plating treatment can be reduced.

With the calculator-equipped watch 10, the case 30 has the external appearance body 32 which constitutes the external appearance area and the support 36 which constitutes the support area and which is separated from the external appearance body 32. In this way, by providing the support separately from the external appearance body as the separate constituent unit, the external appearance body 32 and the support 36 can be manufactured separately, whereby the dimensional accuracy of the support 36 can be set separately from the dimensional accuracy of the external appearance body 32, thereby making it possible to reduce the thickness of the support 36 effectively.

With the calculator-equipped watch 10, the support 36 has the button passage holes 38a through which the key buttons 52 slide downwards and is formed from the material having the higher sliding property with respect to the key buttons 52 than that of the external appearance body 32. As a result, when the key button 52 is pressed, the key button 52 is made to hardly be caught on the corresponding button passage hole 38a, whereby the operability of the key button 52 for a pressing operation can be improved.

In addition, with the calculator-equipped watch 10, the material of the support 36 is polyacetal. As a result, the specific material can be provided which can provide the superior sliding property for the support 36.

With the calculator-equipped watch 10, the key button unit 50 has the multiple key buttons 52, and the collar 54 is provided substantially into the sheet which connects the adjacent multiple key buttons 52. With this configuration, in the calculator-equipped watch 10 including the key button unit 50 having the multiple key buttons 52, the thickness of the support 36 can be reduced, whereby the deterioration in operability of the key button unit 50 can be suppressed.

The calculator-equipped watch 10 according to the first embodiment includes the watch module 20 as a module, and the watch module 20 has the display area 26 for displaying numerals and times. As a result, in the calculator-equipped watch 10 including the display area 26 for displaying numerals and times, the configuration can be realized which can provide the superior operability of the key button unit 50.

### (Second Embodiment)

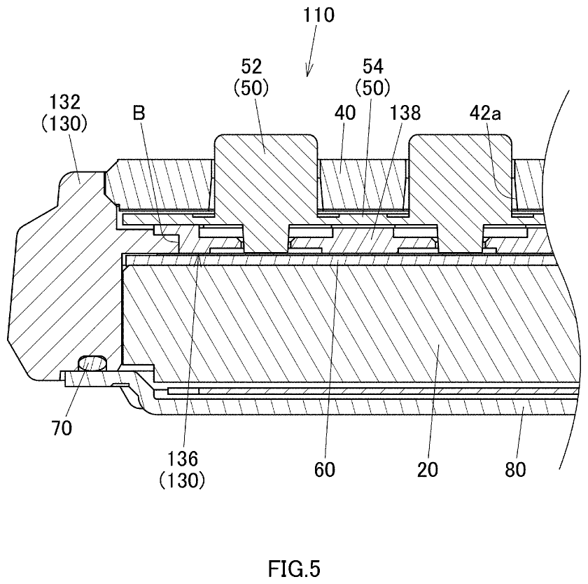

Next, referring to FIG. 5, a second embodiment of the present disclosure will be described. As shown in FIG. 5, a calculator-equipped watch 110 according to the second embodiment differs from the calculator-equipped watch 10 of the first embodiment in that a case 130 has an external appearance area 132 constituting an external appearance of the calculator-equipped watch 110 and a support area 136 which is provided integrally together with the external appearance area 132. The other configurations are similar to those of the calculator-equipped watch 10 of the first embodiment, and hence, the description thereof will be omitted or simplified here.

In the calculator-equipped watch 110 according to the second embodiment, the support area 136 is provided integrally together with the external appearance area 132 in the same area as the area where the support 36 is provided in the calculator-equipped watch 10 of the first embodiment. As a result, no gap is provided between the external appearance area 132 and the support area 136, whereby the support area 136 is provided in such a manner as to continue from the external appearance area 132 via a boundary portion B. As with the support 36 of the first embodiment, the support area 136 is made up of a panel unit 138 of a substantially laterally elongated panel shape and functions as an area where a collar 54 is supported on the case 130.

In the second embodiment, the external appearance area 132 and the support area 136 of the case 130 are integrally molded together through two-color molding in which different resins (different materials) or differently colored resins are combined to be molded integrally in one molding cycle. In this way, as a result of the two-color molding being carried out, the external appearance area 132 and the support area 136 are molded from different resins under different molding conditions. Specifically speaking, the external appearance area 132 is formed from an ABS resin as with the external appearance body of the first embodiment, and the support area 136 is formed from a polycarbonate resin to which a plating treatment is hardly applied. As a result, a gold plating treatment is applied to the external appearance area 132, while a risk that a gold plating treatment is applied to the support area 136 is eliminated.

Thus, as has been described heretofore, with the calculator-equipped watch 110 of the second embodiment, the different materials can be used for the external appearance area 132 and the support area 136 as a result of being molded integrally together through the two-color molding, and hence, in the manufacturing process, molding conditions for the support area 136 can be set differently from molding conditions for the external appearance area 132. As a result, as with the calculator-equipped watch 10 of the first embodiment, a dimensional accuracy of the support area 136 can be enhanced at the time of molding, thereby making it possible to realize a reduction in thickness of the support area 136. As a result, a key button unit 50 can be restrained from being pressed to buckle, whereby the operability of the key button unit 50 can be restrained from being deteriorated.

In addition, with the calculator-equipped watch 110 according to the second embodiment, the material of the support area 136 is polycarbonate. As a result, a plating treatment is hardly applied to the support area 136, thereby making it possible to eliminate a risk that a plating treatment is applied to the support area 136 when a plating treatment is applied to the external appearance area 132. This enables the surface area to which a plating treatment is applied to be reduced compared with the configuration of the comparison example while preventing the deterioration of the dimensional accuracy of the support area 136 which would result from a plating treatment being applied to the surface of the support area 136, whereby the production cost associated with the plating treatment can be reduced.

The embodiments that have been described heretofore are presented as examples, and hence, there is no intention to limit the scope of the present invention by the embodiments. The novel embodiments can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents. For example, in the embodiments that have been described heretofore, the support and the support area are described as being formed from the polyacetal resin and the polycarbonate resin, respectively. However, the resin materials from which the support and the support area are formed are not limited thereto. In addition, in the embodiments, the gold plating treatment is described as being applied to the external appearance body and the external appearance area. However, the material used for the plating treatment applied to the external appearance unit and the external appearance area is not limited thereto.

What is claimed is:

1. An input apparatus comprising:
a case which accommodates a module; and
a pressing unit having a button configured to be displaced in a certain direction, and a collar area extending into a collar-like shape from an external circumferential surface of the button,
wherein the case has an external appearance area configured to constitute an external appearance of the input apparatus and a support area configured to support the collar area on the case, and
wherein the external appearance area and the support area are formed from materials which differ from each other.

2. The input apparatus according to claim 1,
wherein an external appearance body constituting the external appearance area and a support constituting the support area are separable constituent units, and
wherein the support is disposed on the external appearance body.

3. The input apparatus according to claim 1,
wherein a plating treatment is applied to a surface of the external appearance area, and
wherein no plating treatment is applied to a surface of the support area.

4. The input apparatus according to claim 2,
wherein a plating treatment is applied to a surface of the external appearance area, and
wherein no plating treatment is applied to a surface of the support area.

5. The input apparatus according to claim 1,
wherein the pressing unit has multiple buttons as the button, and
wherein the collar area of the pressing unit is formed substantially into a sheet configured to connect the multiple buttons which lie adjacent to one another.

6. The input apparatus according to claim 2,
wherein the pressing unit has multiple buttons as the button, and
wherein the collar area of the pressing unit is formed substantially into a sheet configured to connect the multiple buttons which lie adjacent to one another.

7. The input apparatus according to claim 1,
wherein the support area has a through hole through which the button is caused to slide in a pressing direction and is formed from a material having a higher sliding property with respect to the button than that of the external appearance area.

8. The input apparatus according to claim 7,
wherein a material of the support is polyacetal.

9. The input apparatus according to claim 2,
wherein the support area has a through hole through which the button is caused to slide in a pressing direction and is formed from a material having a higher sliding property with respect to the button than that of the external appearance area.

10. The input apparatus according to claim 9,
wherein a material of the support is polyacetal.

11. The input apparatus according to claim 1,
wherein the external appearance area and the support area are molded integrally through two-color molding.

12. The input apparatus according to claim 11,
wherein a material of the support area is polycarbonate.

13. The input apparatus according to claim 2,
wherein the external appearance area and the support area are molded integrally through two-color molding.

14. The input apparatus according to claim 13,
wherein a material of the support area is polycarbonate.

15. A watch comprising:
a watch module as the module according to claim 1; and
a display area configured to display a numeral and a time.

16. A watch comprising:
a watch module as the module according to claim 2; and
a display area configured to display a numeral and a time.

17. A watch comprising:
a watch module as the module according to claim 4; and
a display area configured to display a numeral and a time.

18. A watch comprising:
a watch module as the module according to claim 6; and
a display area configured to display a numeral and a time.

19. A watch comprising:
a watch module as the module according to claim 9; and
a display area configured to display a numeral and a time.

20. A watch comprising:
a watch module as the module according to claim 10; and
a display area configured to display a numeral and a time.
